(19) United States
(12) Patent Application Publication
(10) Pub. No.: US 2005/0219140 A1
(43) Pub. Date: Oct. 6, 2005

(54) Antenna construction

(75) Inventors: Edwina Browne, Co. Waterford (IE); Naomi Thompson, Co. Waterford (IE); James Browne, Co. Waterford (IE)

Correspondence Address: BROMBERG & SUNSTEIN LLP, 125 SUMMER STREET, BOSTON, MA, 02110-1618, US

(73) Assignee: Stella Doradus Waterford Limited, Co. Waterford (IE)

(21) Appl. No.: 11/015,584

(22) Filed: Dec. 17, 2004

(30) Foreign Application Priority Data
Apr. 1, 2004 (IE) 2004/0232

(51) Int. Cl. H01Q 21/12

(52) U.S. Cl. 343/814; 343/700 MS; 343/795

(57) ABSTRACT

An antenna is provided with a reflector defining a slot, a feed harness, a plurality of radiating, elements electrically connected to the feed harness through the slot, and a printed circuit board including the feed harness and the radiating elements. The periphery of the slot is laterally separated from the feed harness and from the printed circuit board. The radiating elements and the feed harness may be located on different sides of the reflector. The feed harness and the radiating elements may be formed on an integral pattern structure. The position of the feed harness relative to the positions of the radiating elements may be adjustable.

### CROSS REFERENCE TO RELATED APPLICATIONS

The present application claims priority from Irish application serial number E 2004/0232, filed on Apr. 1, 2004.

1. Technical Field

The present invention relates to an antenna, more particularly to a pattern antenna capable of reliable construction and operation.

2. Background Art

An antenna is a passive device which focuses electromagnetic radiation to attain intended directivity or coverage. A ground plane, or reflector, is a conductive surface which acts to ground the antenna, to direct the radiation as desired, and to shield other directions from stray radiation.

In an antenna where the primary radiating elements are located on a printed circuit board (PCB) and are soldered to a wire network harness, the ground plane is positioned between the primary radiating elements and the supporting network to prevent undesirable radiations from affecting the feed harness. Because this construction involves many elements soldered together, antennas made in this manner are difficult to duplicate and to produce sufficiently accurately. For example, cable lengths may vary, and soldering points may vary in size and in location. As a result, the parameters of each antenna constructed in such a manner must be checked with expensive test equipment at all stages of construction. The resulting antenna is an expensive product.

Pattern antennas may be reproduced accurately and cheaply in quantity without the complications of craftwork and the associated constant testing. In the construction of pattern antennas, often a printed circuit board (PCB) material incorporates both the primary radiating elements and the supporting feed harness network. The printed circuit board may include a dielectric laminate supporting a thin sheet of conductor, e.g., copper or another metal. In addition to such a PCB carrying a network of primary radiating and feed harness elements, a pattern antenna includes a ground plane and may include an enclosing frame, or radome, associated with an external connection or feedpoint.

### SUMMARY OF THE INVENTION

In a first aspect of the invention, there is provided an antenna comprising a reflector defining a slot with a periphery and a printed circuit board containing a feed harness and a plurality of primary radiating elements. The primary radiating elements are electrically connected to the feed harness through the slot and the slot periphery is laterally separated from the feed harness and from the printed circuit board.

In certain embodiments of the invention, the primary radiating elements may be located on one side of the reflector and the feed harness substantially located on the other side. An electrically conducting structure substantially enclosing the feed harness may contain electrically absorbing material positioned between the feed harness and an inner surface.

In other embodiments, at least one non-planar electrically conducting extension having a plurality of fins or corrugations may be coupled to the reflector. An electrically insulating cover may enclose the primary radiating elements between itself and the reflector.

In further embodiments, the feed harness and the primary radiating elements may be formed on an integral pattern structure, either by deposition on or etching from the printed circuit board.

In additional embodiments, the printed circuit board may be planar and the plane of the printed circuit board at a first interior angle with respect to an outer surface of the reflector in the vicinity of the slot. The first interior angle may be between 80 degrees and 100 degrees, and, more specifically, substantially 90 degrees.

In still other embodiments, the printed circuit board may include a first planar printed circuit board element containing the primary radiating elements and a second planar printed circuit board element containing substantially all of the feed harness. The printed circuit board may be integral where a bend in the printed circuit board demarks the first planar printed circuit board element from the second planar printed circuit board element or the printed circuit board may be non integral where the first planar printed circuit board element is coupled to the second planar printed circuit board element.

The first and second printed circuit board elements may be at a second interior angle relative to each other between 80 degrees and 100 degrees, in some cases, substantially 90 degrees. The first printed circuit board element containing the radiating elements may be at a first interior angle of between 80 degrees and 100 degrees, in some cases, substantially 90 degrees, relative to the reflector in the vicinity of the slot.

In still further embodiments, separation between the periphery of the slot and the printed circuit board may be maintained by an electrically insulating material. A flange may extend perpendicular to the plane of the reflector in the vicinity of the slot. The reflector may include a grounded planar surface, a curved grounded surface, a plurality of grounded surfaces, a grounded tubular surface, or a grounded canister.

In a second aspect of the invention, there is provided an antenna comprising a reflector defining a slot with a periphery and radiating elements connected to a feed harness through the slot. The radiating elements are included on a first plane and the feed harness is contained on a second plane. The first plane is at a second interior angle relative to the second plane.

In certain embodiments, the first plane may be at a first interior angle with respect to the plane of the reflector in the vicinity of the slot where the first interior angle may be substantially 90 degrees and the second interior angle may be substantially 90 degrees. The second plane may be parallel to the plane of the reflector in the vicinity of the slot.

In further embodiments, the radiating elements may be located on one side of the reflector and the feed harness substantially located on the other side of the reflector. An electrically conducting structure may substantially enclose the feed harness and electrically absorbing material positioned between the feed harness and an inner surface of the electrically conducting structure. A non-planar electrically conducting extension may be coupled to the reflector. The extension may include a plurality of fins or corrugations. The radiating elements may be contained between the reflector and an electrically insulating cover.

In other embodiments, the feed harness and the radiating elements may be formed on an integral pattern structure, comprise metal, and be stamped from metal sheet.

In additional embodiments, the periphery of the slot may extend perpendicular to the plane of the reflector in the vicinity of the slot. The periphery of the slot may be laterally separated from the feed harness and the separation between the periphery of the slot and the feed harness may include an electrically insulating material.

In a third aspect of the invention, there is provided an antenna comprising a reflector defining a slot with a periphery and radiating elements connected to a feed harness through the slot. The position of the feed harness and the position of the radiating elements with respect to the slot are adjustable.

In some embodiments, the feed harness and the radiating elements are formed on an integral pattern structure. The position of the feed harness and the positions of the radiating elements with respect to the slot may be simultaneously adjustable. The radiating elements may be on one side of the reflector and the feed harness substantially on the other side of the reflector. The position of the feed harness and the positions of the radiating elements with respect to the slot may be manually adjustable, mechanically adjustable, or remotely adjustable.

### BRIEF DESCRIPTION OF THE DRAWINGS

The foregoing features of the invention will be more readily understood by reference to the following detailed description, taken with reference to the accompanying drawings, in which:

FIG. 1A provides an illustrative embodiment of the present invention that includes an integral pattern structure attached to a PCB.

FIG. 1B illustrates a PCB included in the embodiment provided in FIG. 1A.

FIG. 2A provides a cross-sectional view of an illustrative embodiment of the invention further including reflector extensions with fins, reflector flanges, and a cover.

FIG. 2B provides a cross-sectional view of an illustrative embodiment of the invention in FIG. 1A further including reflector extensions with corrugations and a PCB position transducer with associated controller and antenna.

FIGS. 3A and 3B provide cross-sectional views of illustrative embodiments of the present invention that include a non planar integral pattern structure attached to a two-piece PCB and to an integral PCB respectively.

FIGS. 4A-4D provide illustrative embodiments of the present invention incorporating planar and nonplanar reflectors.

FIGS. 5A-5B provide illustrative embodiments of the present invention incorporating multiple antennas.

FIG. 6A provides an illustrative embodiment of the present invention that includes an integral stamped pattern structure.

FIG. 6B illustrates an integral stamped-metal pattern structure included in the embodiment of FIG. 6A.

FIG. 7A provides a cross-sectional view of an illustrative embodiment of the invention in FIG. 6A further including reflector extensions with corrugations

FIG. 7B provides a cross-sectional view of an illustrative embodiment of the present invention in FIG. 6A further including reflector extensions with fins and a cover for radiating elements.

### DETAILED DESCRIPTION OF SPECIFIC EMBODIMENTS

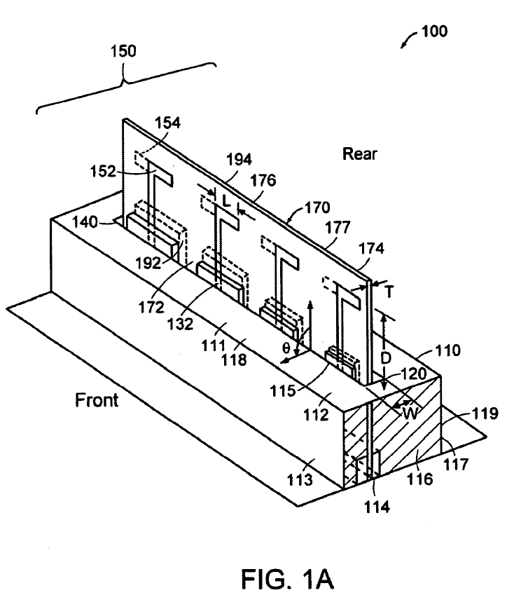

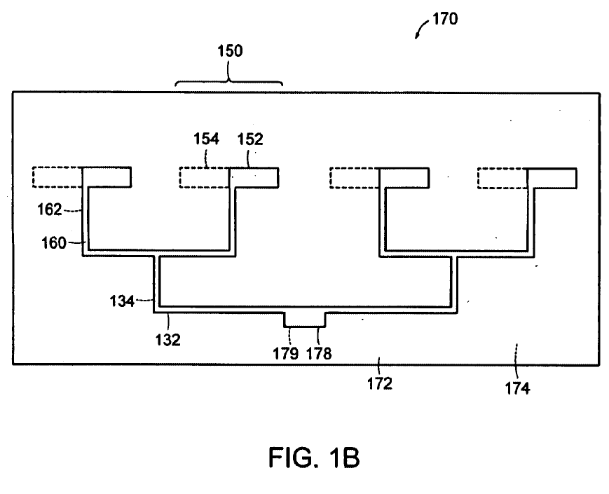

In accordance with embodiments of the present invention, an integral pattern structure and reflector are arranged to provide ease of mounting and of adjustment as well as isolation between primary radiating elements and feed harness. FIG. 1 illustrates an embodiment of the present invention in which an antenna 100 contains a printed circuit board (PCB) 170 mounted orthogonally in relation to a primary reflecting surface 112 of a reflector 110. In FIG. 1A, primary radiating elements 150 are deposits of electrically conducting material. Primary radiating elements 152 reside on the front surface 172 of an electrically insulating board 176 and primary radiating elements 154 reside on the rear surface 174 of the electrically insulating board 176. The electrically insulating property of the board 176 allows separate excitation of the primary radiating elements 152 and 154.

The PCB 170 is shown separately in FIG. 1B. On the front surface 172 of the PCB 170 is located a front integral pattern structure 160 that includes the primary radiating elements 152, the front feed harness 132, and the front input 178. On the rear surface 174 of the PCB 170 is located a rear integral pattern structure 162 that includes the primary radiating elements 154, the rear feed harness 134, and the rear input 179. In the embodiment shown in FIG. 1A and FIG. 1B, the front feed harness 132 overlays the rear feed harness 134, the front input 178 overlays the rear input 179, and the front primary elements 152 overlay the rear primary elements 154 at the edges adjacent to their respective front 132 and rear 134 feed harnesses. Other degrees of overlap are possible.

Feed harness 132 connects to the radiating elements 152 on the front surface 172. Directly behind the feed harness 132 is feed harness 134 (not shown) connecting to the radiating elements 154 on the rear surface 174. In this embodiment, the feed harness 132 distributes an electrical signal from the front input 178 to the four front primary radiating elements 152. Similarly, the feed harness 134 distributes an electrical signal from the rear input 179 to the rear primary radiating elements 154. As a result, adjacent pairs of the primary radiating elements 152 and 154 create radiating dipole fields. The number of dipoles may be larger or smaller than the four illustrated, depending upon the application. Also, although the primary radiating elements 150 are shown as rectangular in shape, other shapes such as triangular or circular are possible.

As an example, embodiments of the invention are applicable to multipoint microwave distribution systems, or MMDS. For frequencies between 2.5 and 2.7 GHz, radiating element length L may be about 26 mm, gap D between the primary radiating elements 150 and the primary reflecting surface 112 may be about 15-50 mm, width W of slot 120 may be about 2 to 10 mm, and thickness T of PCB 170 may be about 1 mm.

FIG. 1A illustrates embodiments where the PCB 170 is mounted within electrically conducting structure 113, including reflector 110 and electrically conducting channel 119, by means of mounting track 114 such that the end of the PCB 170 containing primary radiating elements 150 protrudes outside the electrically conducting structure 113. The radiating elements 150 are located on one side of the reflector 120 and the bulk of the front 132 and rear 134 feed harnesses are located on the other side of the reflector, enclosed within the electrically conducting structure 113.

The patterns of electrical conductors corresponding to integral pattern structures 160 and 162 containing the combinations of feed harness 132 and 134 and primary radiating elements 152 and 154 may be accomplished in several ways. In one case, the integral pattern structures 160 and 162 are directly deposited on the insulating board 176. In another case, an electrical conductor may be deposited over the entire front 172 and rear 174 surface of the insulating board 176 and then selectively etched to establish the integral pattern structures 160 and 162.

The PCB 170 exits the electrically conducting structure 113 through a slot 120 in reflector 110. The slot 120 is preferably sufficiently wide that the PCB 170, and more particularly, feed harness 132 and 134, do not contact a periphery 140 of slot 120 and sufficiently narrow that radiation from the front feed harness 132 or from the rear feed harness 134 is not significantly coupled to the primary radiating structures 150. To further prevent contact between the PCB 170 and periphery 140, electrically insulating standoff 115 may be positioned between the PCB 170 and the slot periphery 140, including between feed harness 132 and 134 and the slot periphery 140.

Although the PCB 170 is shown in FIG. 1A to be orthogonal to outer surface 111 of the reflector 110 in the vicinity of the slot 120, other orientations are possible. First interior angle θ, as measured from the plane 177 of the PCB 170 at a point exterior to the electrically conducting structure 113 to the plane 118 of the reflector 110 in the vicinity of the slot 120, may be between about 80° and 100°.

Another way to suppress interference is to surround feed harness 132 and 134 with material that absorbs stray radiation, often radio frequency radiation. One example is an electrically conducting, yet highly resistive, plastic foam material 116 that fills part or all of the region enclosed by the electrically conducting structure 113, positioned between the front 132 and rear 134 feed harness and inner surface 117 of electrically conducting structure 113.

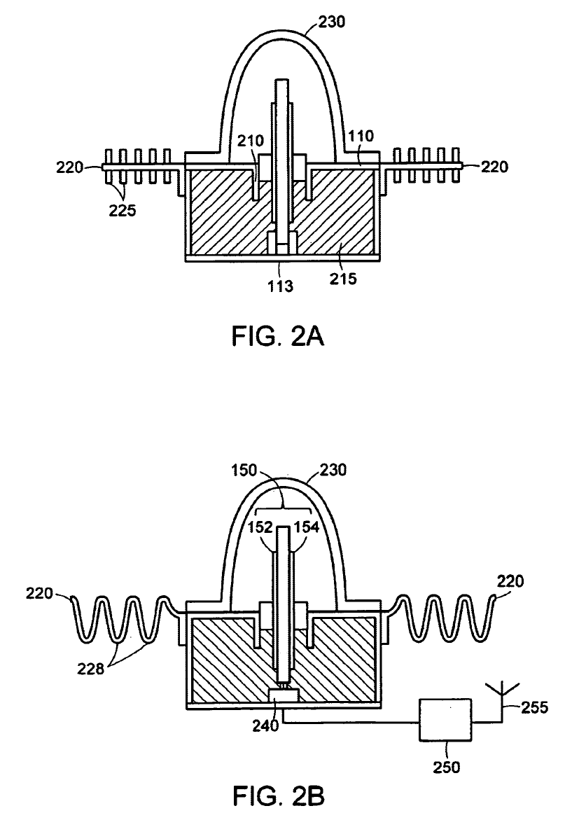

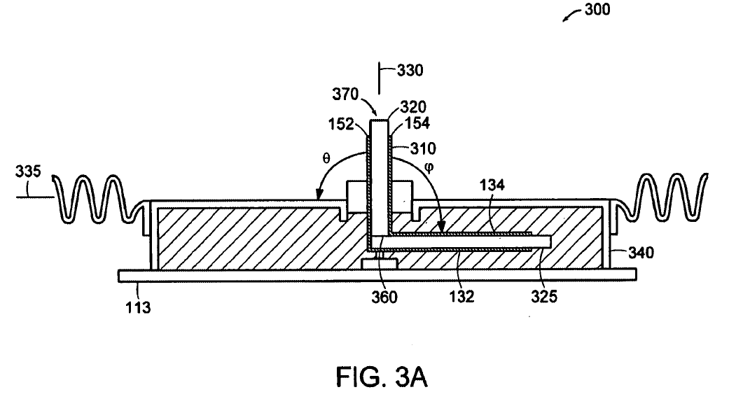

A periphery extension is a still additional way to suppress interference. In a preferred embodiment, the periphery extension constitutes a flange. FIG. 2A illustrates an embodiment incorporating a flange 210 built into the reflector 110 by extending the periphery 140 of the reflector slot 120 perpendicular to the plane of the reflector 110 in a direction toward the interior 215 of the electrically conducting structure 113.

Radiation from primary radiating elements 150 may be enhanced by attaching extensions 220 onto the reflector 110. Extensions 220 may be planar or non planar. FIG. 2A illustrates an embodiment where the extensions 220 are non planar and include fins 225. FIG. 2B illustrates an embodiment where the extensions 220 are non planar and include corrugations 228. In both FIGS. 2A and 2B, the antenna 100 is shown protected from weather in an outdoor installation by an electrically insulating cover or radome 230. Radome 230 may be vacuum formed of plastic, e.g., ABS (Acrylonitrile Butadiene Styrene), and bolted to the reflector 110.

Embodiments discussed to this point have included a planar PCB 170 as well as a planar reflector 110. Embodiments of an antenna that include a folded integral pattern structure, e.g., a two-piece PCB, may have certain advantages. Antennas with a folded integral pattern structure are thinner and may be less susceptible to dislodgement by the wind when mounted outdoors. Such antennas may be less visible, have less weight, and reduce the costs of towers on which they are mounted.

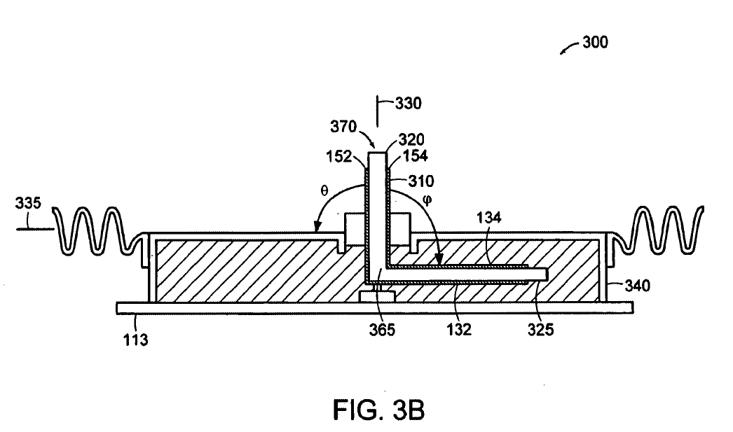

FIG. 3 illustrates an embodiment of an antenna 300 that includes an integral pattern structure 310 spread over a PCB 370 containing a first printed circuit board element 320 and a second printed circuit board element 325. The first PCB element 320 contains primary radiating elements 152 and 154 and the second PCB element 325 contains the bulk of feed harnesses 132 and 134. The orientation of the PCB 370 is given by first interior angle 0 as measured from the first PCB plane 330 exterior to electrically conducting structure 113 and the reflector plane 335 and second interior angle Φ as measured from the first PCB plane 330 exterior to electrically conducting structure 113 and second PCB plane 340. Although shown as orthogonal in FIG. 3, both θ and Φ may have values between about 80° and 100°.

FIG. 3A shows PCB 370 as non integral, i.e., comprising separate pieces. Initially separate first PCB element 320 and second PCB element 325 are coupled together at joint 360 to form PCB 370. PCB 370 can also be integral, i.e., comprising a single piece. FIG. 3B illustrates PCB 370 as integral, bent to form first PCB element 320 and second PCB element 325 where bend 365 demarks the first PCB element 320 from the second PCB element 325.

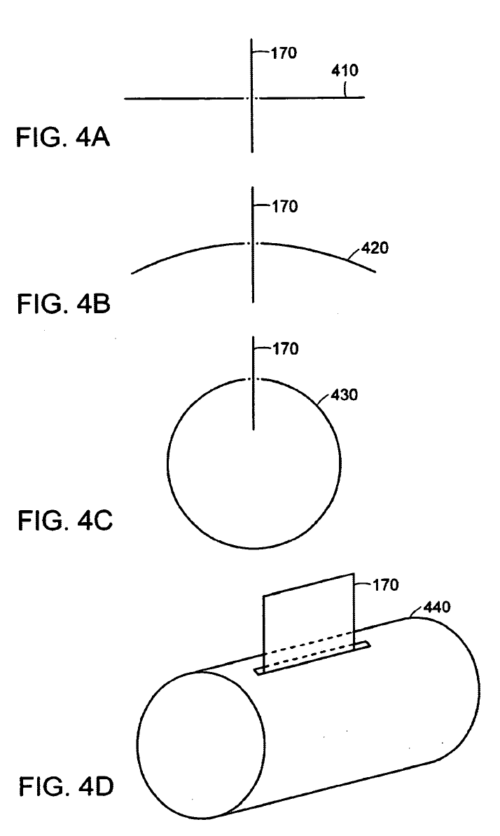

FIG. 4 illustrates embodiments of the invention that utilize various types of reflector shapes and antenna configurations. A plane surface reflector 410 is shown in FIG. 4A, a curved surface reflector 420 is shown in FIG. 4B, an open tube reflector 430 is shown in FIG. 4C, and a closed tube reflector 440, i.e., a canister, is shown in FIG. 4D. Other reflector shapes are also possible.

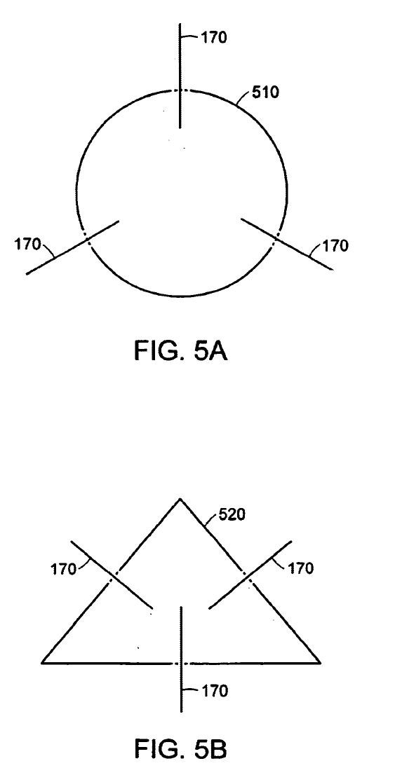

FIG. 5 illustrates embodiments of the invention incorporating multiple antennas. In FIG. 5A, multiple PCBs 170 are arrayed about a cylindrical reflector 510. In FIG. 5B, multiple PCBs 170 are distributed about a reflector 520 having three plane sides. These examples are illustrative, as a reflector may include multiple surfaces and antennas of different shape and of different number. A reflector may incorporate several antennas connected together to produce specific results such as an omni directional pattern with restricted elevation.

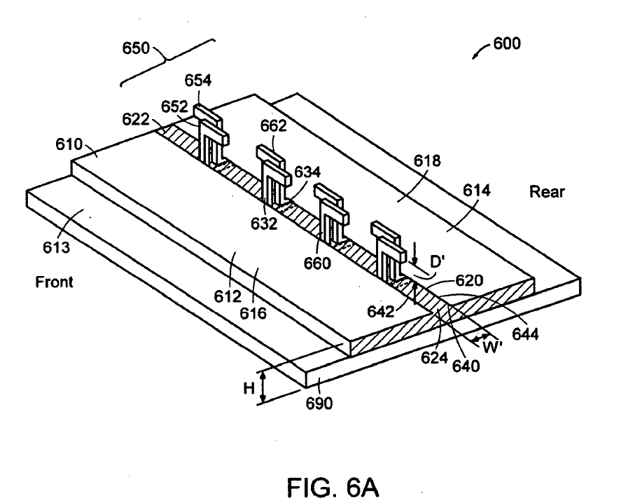

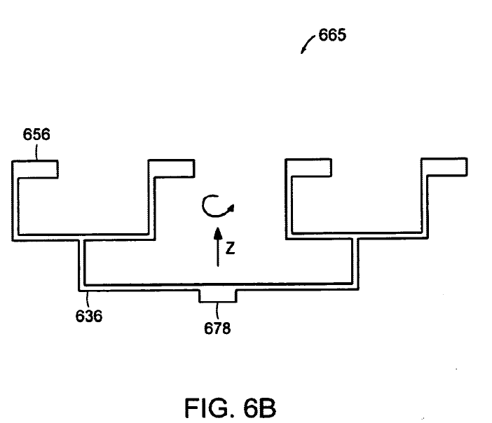

FIG. 6 illustrates an embodiment of the invention that incorporates another type of integral pattern structure and another type of reflector. In FIG. 6A, pattern antenna 600 includes a front integral pattern structure 660 and a rear integral pattern structure 662 as well as a reflector 610 that is included in electrically conducting structure 613. In pattern antenna 600, the front integral pattern structure 660 includes front primary radiating elements 652 and front feed harness 632, and the rear integral pattern structure 662 includes rear primary radiating elements 654 and rear feed harness 634. The reflector 610 includes two sections, front reflector section 612 and rear reflector section 614. Width W′ of slot 620 is defined by the separation between the front reflector section 612 and the rear reflector section 614. In this embodiment, a slot periphery 640 includes a front section periphery 642 and a rear section periphery 644, where the slot 620 is open at left slot end 622 and right slot end 624. Width W′ is arranged so that the front integral pattern structure 660 and the rear integral pattern structure 662 are free from contact with the front section periphery 642 and with the rear section periphery 644. Slot width W′ may be maintained by attachment of the front reflector section 612 and the rear reflector section 614 to base 690. Attachment may be by screws, adhesive, welding, or similar means.

FIG. 6B illustrates an embodiment of an integral pattern structure 665 prior to assembly in antenna 600. Integral pattern structure 665 is made of an electrically conducting material metal sufficiently thick to be self-supporting and sufficiently thin to be stamped from a larger piece. If the integral pattern structure 665 is made from copper, a thickness of about 0.5 mm to 1 mm is acceptable. The integral pattern structure 665 includes primary radiating elements 656, feed harness 636, and input 678. The integral pattern structure 665 may serve as both the front 660 and the rear 662 integral pattern structures by suitably rotating the integral pattern structure 665 about axis Z.

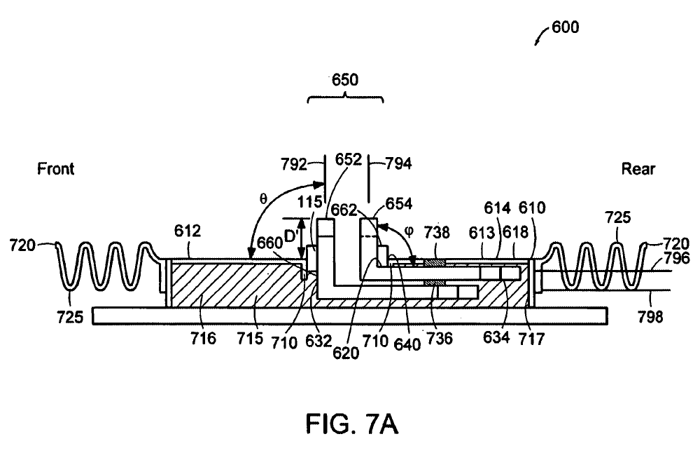

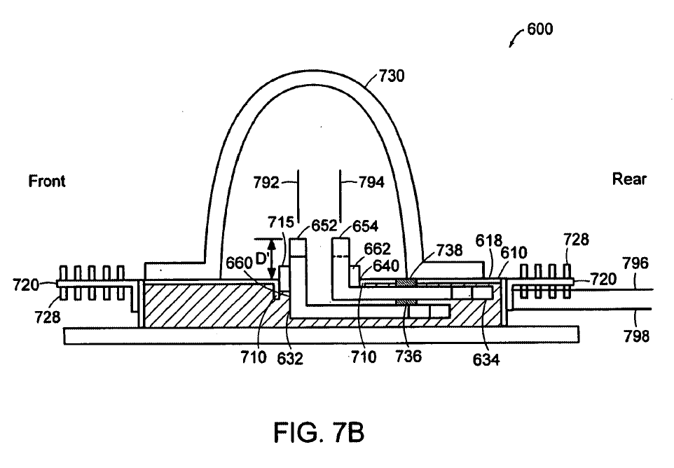

FIGS. 7A and 7B illustrates cross-sectional views of antenna 600. The front integral pattern structure 660 and the rear integral pattern structure 662 are bent such the front primary radiating elements 652 and the rear primary radiating elements 654 lie within planes parallel to front first plane 792 and rear first plane 794 and are positioned a distance D′ above the primary reflecting surfaces 612 and 614 of the reflector 610. The substantial portion of front feed harness 632 and of rear feed harness 634 is parallel to front second plane 796 and rear second plane 798 and are orthogonal to the front first plane 792 of front primary radiating elements 652 and to the rear first plane 794 of the rear primary radiating elements 654. The front integral pattern structure 660 and the rear integral pattern structure 662 are coupled together by an electrically insulating coupling pattern structure coupling 736 and the combination of front integral pattern structure 660 and rear integral pattern structure 662 is held by an electrically insulating spacer 738 so as to position the front 652 and the rear 654 primary radiating elements at distance D′ above the primary reflecting surfaces 612 and 614.

FIG. 7A illustrates an embodiment incorporating a periphery extension 710 built into the reflector 610 by extending the periphery 640 of the reflector slot 620 perpendicular to the plane of the reflector 610 in a direction toward the interior 715 of the electrically conducting structure 613.

Radiation from primary radiating elements 650 may be enhanced by attaching extensions 720 onto the reflector 610. FIG. 7A illustrates an embodiment where the extensions are non planar and includes corrugations 725. FIG. 7B illustrates an embodiment where non planar extensions 720 include fins 728. In FIG. 7B, the antenna 600 is shown protected from weather in an outdoor installation by an electrically insulating cover or radome 730. Radome 730 may be vacuum formed of plastic, e.g., ABS (Acrylonitrile Butadiene Styrene), and bolted to the reflector 610.

An antenna is designed to generate a specific radiation pattern. Since the antenna radiation pattern is sensitive to the positions of the primary radiating elements relative to the position of the ground plane, heights D and D′ corresponding respectively to the distance of primary radiating elements 150 above primary reflecting surface 112 and to the distance of primary radiating elements 650 above primary reflecting surfaces 612 and 614 contribute to determining antenna performance.

Heights D and D′ may be adjusted by several means. In FIG. 1A for antenna 100, the position of the PCB 170 relative to the primary reflecting surface 112 (D) may be altered manually by raising or lowering the end of PCB 170 within mounting track 114 where PCB 170 is held in position by frictional attachment both to mounting track 114 and to insulating standoffs 115 if the latter are present. In FIG. 7A, front 660 and rear 662 integrated pattern structures are held together by electrically insulating spacer 736. The heights of both the front 652 and rear 654 primary radiating elements may be simultaneously adjusted by selecting electrically insulating spacers 738 of different widths.

Often, antennas 100 and 600 are mounted in positions difficult to reach, for example, on towers, where manual adjustment of radiation patterns is not convenient. In such a situation, the position of the radiating elements 150 and 650 relative to the refectors 110 and 610 respectively may also be varied mechanically, as when the bottom of the PCB 170 is connected to a transducer 240 such as a stepper motor as shown in FIG. 2B. When the transducer 240 is connected to a controller 250, the position of the radiating elements 150 may be adjusted remotely on the basis of a signal received by antenna 255.

The described embodiments of the invention are intended to be merely exemplary and numerous variations and modifications will be apparent to those skilled in the art. All such variations and modifications are intended to be within the scope of the present invention as defined in the appended claims.

1. An antenna, the antenna comprising:
a reflector defining a slot having a periphery;
a feed harness;
a plurality of radiating elements, the radiating elements electrically connected to the feed harness through the slot; and
a printed circuit board, the printed circuit board including the feed harness and the radiating elements;
wherein the periphery of the slot is laterally separated from the feed harness and from the printed circuit board.

2. An antenna according to claim 1, wherein the radiating elements are located on one side of the reflector and the feed harness is substantially located on the other side of the reflector.

3. An antenna according to claim 2, further including an electrically conducting structure, the electrically conducting structure substantially enclosing the feed harness.

4. An antenna according to claim 3, further including electromagnetically absorbing material, the electrically absorbing material substantially enclosed by the electrically conducting structure.

5. An antenna according to claim 4, wherein the electromagnetically absorbing material is positioned between the feed harness and an inner surface of the electrically conducting structure.

6. An antenna according to claim 2, further including at least one electrically conducting extension coupled to the reflector.

7. An antenna according to claim 6, wherein the electrically conducting structure further includes a plurality of fins.

8. An antenna according to claim 6, wherein the electrically conducting extension further includes a plurality of corrugations.

9. An antenna according to claim 2, further including an electrically insulating cover, the radiating elements contained between the electrically insulating cover and the reflector.

10. An antenna according to claim 1, wherein the feed harness and the radiating elements are formed on an integral pattern structure.

11. An antenna according to claim 10, wherein the integral pattern structure is deposited on the printed circuit board.

12. An antenna according to claim 10, wherein the integral pattern structure results from etching.

13. An antenna according to claim 1, wherein the printed circuit board is planar and the plane of the printed circuit board is at a first interior angle with respect to an outer surface of the reflector in the vicinity of the slot.

14. An antenna according to claim 13, wherein the first interior angle is between 80 degrees and 100 degrees.

15. An antenna according to claim 14, wherein the first interior angle is substantially 90 degrees.

16. An antenna according to claim 1, wherein the printed circuit board includes a first planar printed circuit board element containing the radiating elements and a second planar printed circuit board element containing substantially all of the feed harness, the first printed circuit board element and the second printed circuit board element being at a second interior angle relative to each other.

17. An antenna according to claim 16, wherein the printed circuit board is integral and a bend in the printed circuit board demarks the first planar printed circuit board element from the second planar printed circuit board element.

18. An antenna according to claim 16, wherein the printed circuit board is not integral and the first planar printed circuit board element is coupled to the second planar printed circuit board element.

19. An antenna according to claim 16, wherein the second interior angle is between 80 degrees and 100 degrees.

20. An antenna according to claim 19, wherein the second interior angle is substantially 90 degrees.

21. An antenna according to claim 16, wherein the first planar printed circuit board element contains the radiating elements, the first planar circuit board element at a first interior angle with respect to the reflector in the vicinity of the slot.

22. An antenna according to claim 20, wherein the first interior angle is between 80 degrees and 100 degrees.

23. An antenna according to claim 22, wherein the first interior angle is substantially 90 degrees.

24. An antenna according to claim 21, wherein the second interior angle is substantially 90 degrees.

25. An antenna according to claim 1, wherein the separation between the periphery of the slot and the printed circuit board is maintained by an electrically insulating material.

26. An antenna according to claim 1, further including a flange extending perpendicular to the plane of the reflector in the vicinity of the slot.

27. An antenna according to claim 1, wherein the reflector includes a grounded planar surface.

28. An antenna according to claim 1, wherein the reflector includes a curved grounded surface.

29. An antenna according to claim 1, wherein the reflector includes a plurality of grounded surfaces.

30. An antenna according to claim 1, wherein the reflector includes a grounded tubular surface.

31. An antenna according to claim 30, wherein the reflector includes a grounded canister.

32. An antenna, the antenna comprising:
a reflector defining a slot having a periphery;
a feed harness; and
a plurality of radiating elements electrically connected to the feed harness through the slot;
wherein the radiating elements are included on a first plane and the feed harness is substantially included on a second plane; and
wherein the first plane is at a second interior angle with respect to the second plane.

33. An antenna according to claim 32, wherein the first plane is at a first interior angle with respect to the reflector in the vicinity of the slot.

34. An antenna according to claim 33, wherein the first interior angle is substantially 90 degrees.

35. An antenna according to claim 34, wherein the second interior angle is substantially 90 degrees.

36. An antenna according to claim 32, wherein the second plane is substantially parallel to the plane of the reflector in the vicinity of the slot.

37. An antenna according to claim 32, wherein the radiating elements are located on one side of the reflector and the feed harness is substantially located on the other side of the reflector.

38. An antenna according to claim 37, further including an electrically conducting structure, the electrically conducting structure substantially enclosing the feed harness.

39. An antenna according to claim 38, further including electromagnetically absorbing material, the electrically absorbing material enclosed by the electrically conducting structure.

40. An antenna according to claim 39, wherein the electromagnetically absorbing material is positioned between the feed harness and an inner surface of the electrically conducting structure.

41. An antenna according to claim 37, further including at least one electrically conducting extension coupled to the reflector.

42. An antenna according to claim 41, wherein the electrically conducting extension further includes a plurality of fins.

43. An antenna according to claim 41, wherein the electrically conducting extension further includes a plurality of corrugations.

44. An antenna according to claim 37, further including an electrically insulating cover, the radiating elements contained between the electrically insulating cover and the reflector.

45. An antenna according to claim 32, wherein the feed harness and the radiating elements are formed on an integral pattern structure.

46. An antenna according to claim 45, wherein the feed harness and the radiating elements comprise a metal.

47. An antenna according to claim 46 wherein the feed harness and radiating elements are stamped from a metal sheet.

48. An antenna according to claim 32, wherein the periphery of the slot extends perpendicular to the plane of the reflector in the vicinity of the slot.

49. An antenna according to claim 32, wherein the periphery of the slot is laterally separated from the feed harness.

50. An antenna according to claim 49, wherein the separation between the periphery of the slot and the feed harness includes an electrically insulating material.

51. An antenna, the antenna comprising:
a reflector defining a slot having a periphery;
a feed harness; and
a plurality of radiating elements, the radiating elements electrically connected to the feed harness through the slot;
wherein the position of the feed harness and the positions of the radiating elements with respect to the slot are adjustable.

52. An antenna according to claim 51, wherein the feed harness and the radiating elements are formed on an integral pattern structure.

53. An antenna according to claim 51, wherein the position of the feed harness and the positions of the radiating elements with respect to the slot are simultaneously adjustable.

54. An antenna according to claim 51, wherein the radiating elements are on one side of the reflector and the feed harness is substantially on the other side of the reflector.

55. An antenna according to claim 51, wherein the position of the feed harness and the positions of the radiating elements with respect to the slot are manually adjustable.

56. An antenna according to claim 51, wherein the position of the feed harness and the positions of the radiating elements with respect to the slot are mechanically adjustable.

57. An antenna according to claim 56, wherein the position of the feed harness and the positions of the radiating elements with respect to the slot are remotely adjustable.
